(19) United States
(12) Patent Application Publication
(10) Pub. No.: US 2024/0093002 A1
(43) Pub. Date: Mar. 21, 2024

(54) CURABLE COMPOSITION AND OPTICAL MATERIAL COMPRISING SAME

(71) Applicant: LG CHEM, LTD., Seoul (KR)

(72) Inventors: Soonhwa JUNG, Daejeon (KR); Jeewoo LIM, Daejeon (KR); Yeongrae CHANG, Daejeon (KR); Jisung CHOI, Daejeon (KR)

(73) Assignee: LG CHEM, LTD., Seoul (KR)

(21) Appl. No.: 18/262,528

(22) PCT Filed: Mar. 8, 2022
(86) PCT No.: PCT/KR2022/003257

§ 371 Date: Jul. 21, 2023

(30) Foreign Application Priority Data
Mar. 10, 2021 (KR) 10-2021-0031499
Mar. 2, 2022 (KR) 10-2022-0026941

(51) Int. Cl. C08K 5/45; C08K 3/06; C08K 3/30; C08L 81/04; G02B 1/04

(52) U.S. Cl. CPC C08K 5/45; C08K 3/06; C08K 3/30; C08L 81/04; G02B 1/041; C08K 2003/3009; C08K 2201/003

(57) ABSTRACT

This invention relates to a curable composition for forming high refractive index optical material and optical material comprising the same, and more specifically, to a curable composition for forming high refractive index optical material comprising an episulfide compound and a sulfur-containing polymer compound, and optical material comprising the same.

### CROSS-REFERENCE TO RELATED APPLICATION(S)

This application is a 35 U.S.C. 371 National Phase Entry Application from PCT/KR2022/003257, filed on Mar. 8, 2022, which claims the benefit of and priority of Korean Patent Application No. 10-2021-0031 499 filed on Mar. 10, 2021 and Korean Patent Application No. 10-2022-0026941 filed on Mar. 2, 2022 in the Korean Intellectual Property Office, all of the contents of which are incorporated herein by reference in their entirety.

### FIELD OF THE INVENTION

The present disclosure relates to a curable composition for forming a high refractive index optical member, and an optical material including the same BACKGROUND

High refractive index polymer (HRIP) is generally defined as a polymer material having a refractive index of 1.50 or more, and is applied as coating/sealing materials for increasing light extraction efficiency of light emitting diodes (LEDs), or microlens materials for image sensors.

General glass lenses may give serious damage to the eyeball of a user when broken, and it has high density and thus heavy weight, thus causing discomfort during extended-wear, but lenses using a high-refractive polymer are lighter than glass lens and thus is comfort to wear, is not easily damaged, and even if damaged, is relatively safer than glass lens, and enables realization of various colors.

However, since the refractive index and chromatic aberration (Abbe number) generally have a trade-off relationship in a high-refractive-refractive-index polymer, there is a problem that a lens or the like using such a high-refractive index polymer has a relatively low Abbe number. When the glass transition temperature is low and thus the lens is used for devices or the like, there is a problem that deformation occurs due to heat generation or the like.

### BRIEF SUMMARY

It is an object of the invention to provide a curable composition for forming high refractive index optical material that is lighter than glass or tempered glass used in the existing lenses, and the like, has excellent strength and hardness, enables realization of various colors, enables realization of high refractive index, has low yellow index value and thus has excellent optical properties, and has high glass transition temperature and thus is less deformed, and optical material comprising the same.

Provided herein is a curable composition for forming high refractive index optical material comprising an episulfide compound and a sulfur-containing polymer compound.

Also provided herein is an optical material comprising an episulfide compound and a sulfur-containing polymer compound.

Hereinafter, a curable composition and an optical material comprising the same according to specific embodiments of the invention will be explained in detail.

### DETAILED DESCRIPTION

The terms used herein are only to explain specific embodiments, and are not intended to limit the present disclosure. A singular expression includes a plural expression thereof, unless it is expressly stated or obvious from the context that such is not intended.

As used herein, the terms “comprise” or “have”, etc. are intended to designate the existence of a specific feature, region, integer, step, action, element and/or component, but does not exclude the presence or addition of a different specific feature, region, integer, step, action, element, component and/or group.

As used herein, an “episulfide compound” means a compound comprising one or more episulfides, wherein the episulfide means a compound in which the oxygen (O) atom of epoxide is substituted with a sulfur(S) atom.

As used herein, “sulfur-containing polymer compound” mean a polymer which essentially comprises sulfur atoms.

As used herein, ‘curing’ means both thermal curing and photocuring, and a ‘curable composition’ means a thermally curable and/or photocurable composition.

As used herein, a high refractive index means a refractive index of about 1.600 or more at a wavelength region of 350 to 800 nm or at a wavelength of 632.8 nm.

As used herein, the term “substituted or unsubstituted” means being unsubstituted or substituted with one or more substituents selected from the group consisting of deuterium; a halogen group; a nitrile group; a nitro group; a hydroxy group; a carbonyl group; an ester group; an imide group; an amino group; a phosphine oxide group; an alkoxy group; an aryloxy group; an alkylthioxy group; an arylthioxy group; an alkylsulfoxy group; an arylsulfoxy group; a silyl group; a boron group; an alkyl group; a cycloalkyl group; an alkenyl group; an aryl group; an aralkyl group; an aralkenyl group; an alkylaryl group; an alkylamine group; an aralkylamine group; a heteroarylamine group; an arylamine group; an arylphosphine group; and a heterocyclic group containing at least one of N, O and S atoms, or being unsubstituted or substituted with a substituent to which two or more substituents of the above-exemplified substituents are linked. For example, “a substituent in which two or more substituents are linked” may be a biphenyl group. Namely, a biphenyl group may be an aryl group, or it may also be interpreted as a substituent in which two phenyl groups are linked.

According to an embodiment of the invention, there is provided a curable composition for forming high refractive index optical material, comprising an episulfide compound and a sulfur-containing polymer compound, wherein the sulfur-containing polymer compound comprises at least one repeat unit selected from the group consisting of a repeat unit containing Sₙ₊₁ (n is an integer of 1 to 20) and a repeat unit containing selenium and sulfur.

The present inventors discovered that a composition comprising an episulfide compound and a sulfur-containing polymer compound and an optical material comprising the same, are lighter than glass or tempered glass used in the existing lenses, and the like, have excellent physical properties such as strength and hardness, and the like, have high transmittance and low yellow index (Y.I.) and thus have excellent optical properties, have high glass transition temperature and thus less thermal deformation, and therefore, can provide optical material capable of replacing previously used glass or plastic material, and completed the invention.

Thus, the curable composition and optical material comprising the same can replace the existing glass or optical glass, and be usefully applied as a display substrate, a display protection film, a touch panel, lens of image sensor such as wearable device, coating/sealing materials for enhancing the light extraction efficiency, such as light emitting diode (LED), and the like.

The sulfur-containing polymer compound included in the curable composition may include at least one repeat unit selected from the group consisting of a repeat unit containing Sₙ₊₁ (n is an integer of 1 to 20) and a repeat unit containing selenium and sulfur.

The sulfur-containing polymer compound can be used as a curing agent for curing the curable composition containing the episulfide compound, whereby while improving optical properties regarding the transmittance, haze, and yellowness of the optical material, which is a cured product of the curable composition, the glass transition temperature can be increased to 65° C. or more, and a high refractive index of 1.710 or more can be exhibited.

For example, the sulfur-containing polymer compound may include a repeat unit represented by the Chemical Formula 1 or 2.

[symbol]

R₁—Sₙ₊₁ [symbol] [Chemical Formula 1]
in the Chemical Formula 1,
R₁ is a substituted or unsubstituted alkylene having 1 to 20 carbon atoms; a substituted or unsubstituted cycloalkylene having 3 to 40 carbon atoms; a substituted or unsubstituted arylene having 5 to 30 carbon atoms; a substituted or unsubstituted heteroarylene having 2 to 30 carbon atoms containing at least one of oxygen (O), nitrogen (N) and sulfur (S) atoms; —RₐOR_{b}—; —R_{c}COOR_{d}—; —RₑSO₂R_{f}— or —R_{g}SORₕ—, Rₐ to Rₕ are each independently a single bond, a substituted or unsubstituted alkylene having 1 to 20 carbon atoms, a substituted or unsubstituted cycloalkylene having 3 to 40 carbon atoms, or a substituted or unsubstituted arylene having 5 to 30 carbon atoms,
n is an integer of 1 to 20,

[symbol]

R₂—Sₐ—Se—S_{b} [symbol] [Chemical Formula 2]
in Chemical Formula 2,
R₂ is a substituted or unsubstituted alkylene having 1 to 20 carbon atoms; a substituted or unsubstituted cycloalkylene having 3 to 40 carbon atoms; a substituted or unsubstituted arylene having 5 to 30 carbon atoms; a substituted or unsubstituted heteroarylene having 2 to 30 carbon atoms containing at least one of oxygen (O), nitrogen (N) and sulfur (S) atoms; —RₐOR_{b}—; —R_{c}COOR_{d}—; —RₑSO₂R_{f}— or —R_{g}SORₕ—, Rₐ to Rₕ are each independently a single bond, a substituted or unsubstituted alkylene having 1 to 20 carbon atoms, a substituted or unsubstituted cycloalkylene having 3 to 40 carbon atoms, or a substituted or unsubstituted arylene having 5 to 30 carbon atoms,
a and b are each independently an integer of 0 or more and 10 or less, and
a+b is an integer of 1 or more and 20 or less.

For example, a and b may be each independently 0 or more and 7 or less, 0 or more and 5 or less, or 1 or more and 3 or less, and a+b may be 1 or more and 10 or less, 2 or more and 7 or less, or 3 or more and 5 or less.

In Chemical Formula 1, n may be 1 to 20, 1 to 18, 5 to 15, or 8 to 13. For example, the Chemical Formula 1 may be a repeat unit represented by the following Chemical Formulas 1-1 or 1-2.

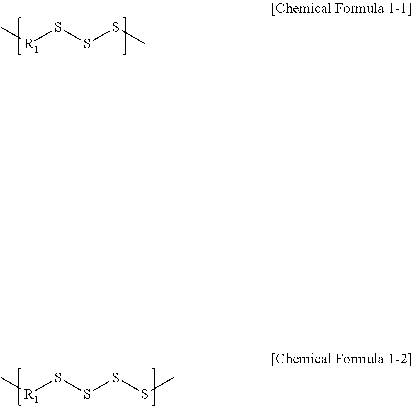

in Chemical Formulas 1-1 and 1-2, R₁ is as defined above.

Further, the Chemical Formula 2 may be one selected from repeat units represented by the following Chemical Formulas 2-1 to 2-4.

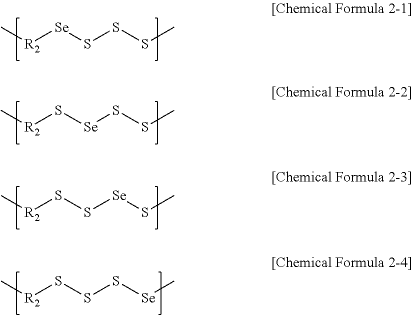

in Chemical Formulas 2-1 and 2-4, R₂ is as defined above.
In the definitions of R₁ and R₂, the substituted or unsubstituted alkylene having 1 to 20 carbon atoms may be methylene, ethylene, propylene, isopropylene, butylene, isobutylene, tert-butylene, pentylene, isopentylene, neopentylene, tert-pentylene, hexylene, 2-methylpentylene, heptylene, 1-ethylpentylene, octylene, 2-ethylhexylene, isooctylene, nonylene, isononylene, decylene, isodecylene, undecylene or dodecylene.

Further, the alkylene having 1 to 20 carbon atoms may be substituted with a halogen group, and for example, the halogen group may be a fluoro group, a bromo group, or a chloro group.

Further, in the definition of R₁ and R₂, a substituted or unsubstituted cycloalkylene having 3 to 40 carbon atoms may be 1,3-cyclopentylene, 1,3-(2-methyl)cyclopentylene, 1,4-(2-methyl)cyclopentylene, 1,5-(2-methyl)cyclopentylene, 1,3-(2-ethyl)cyclopentylene, 1,4-(2-ethyl)cyclopentylene and 1,5-(2-ethyl)cyclopentylene, 1,2-cyclohexylene, 1,3-cyclohexylene, 1,4-cyclohexylene, 1,3-(2-methyl)cyclohexylene, 1,4-(2-methyl)cyclohexylene, 1,5-(2-methyl)cyclohexylene and 1,6-(2-methyl)cyclohexylene, 1,3-(2-ethyl)cyclohexylene, 1,4-(2-ethyl)cyclohexylene, 1,5-(2-ethyl)cyclohexylene, 1,6-(2-ethyl)cyclohexylene, 1,3-(2-propyl)cyclohexylene, 1,4-(2-propyl)cyclohexylene, 1,5-(2-propyl)cyclohexylene, 1,6-(2-propyl)cyclohexylene, 1,3-(2-isopropyl)cyclohexylene, 1,4-(2-isopropyl)cyclohexylene, 1,5-(2-isopropyl)cyclohexylene, 1,6-(2-isopropyl)cyclohexylene, 1,3-(2-butyl)cyclohexylene, 1,4-(2-butyl)cyclohexylene, 1,5-(2-butyl)cyclohexylene and 1,6-(2-butyl)cyclohexylene, 1,3-(2-sec-butyl)cyclohexylene, 1,4-(2-sec-butyl)cyclohexylene, 1,5-(2-sec-butyl)cyclohexylene, 1,6-(2-sec-butyl)cyclohexylene, 1,3-(2-tert-butyl)cyclohexylene, 1,4-(2-tert-butyl)cyclohexylene, 1,5-(2-tert-butyl)cyclohexylene, 1,6-(2-tert-butyl)cyclohexylene, 1,2-cycloheptylene, 1,3-cycloheptylene, 1,4-cycloheptylene, 1,3-(2-methyl)cycloheptylene, 1,4-(2-methyl)cycloheptylene, 1,5-(2-methyl)cycloheptylene, 1,6-(2-methyl)cycloheptylene and 1,7-(2-methyl)cycloheptylene, 1,3-(2-ethyl)cycloheptylene, 1,4-(2-ethyl)cycloheptylene, 1,5-(2-ethyl)cycloheptylene, 1,6-(2-ethyl)cycloheptylene and 1,7-(2-ethyl)cycloheptylene, 1,3-(2-propyl)cycloheptylene, 1,4-(2-propyl)cycloheptylene, 1,5-(2-propyl)cycloheptylene, 1,6-(2-propyl)cycloheptylene, 1,7-(2-propyl)cycloheptylene, 1,3-(2-isopropyl)cycloheptylene, 1,4-(2-isopropyl)cycloheptylene, 1,5-(2-isopropyl)cycloheptylene, 1,6-(2-isopropyl)cycloheptylene, 1,7-(2-isopropyl)cycloheptylene, 1,3-(2-butyl)cycloheptylene, 1,4-(2-butyl)cycloheptylene, 1,5-(2-butyl)cycloheptylene, 1,6-(2-butyl)cycloheptylene and 1,7-(2-butyl)cycloheptylene, 1,3-(2-sec-butyl)cycloheptylene, 1,4-(2-sec-butyl)cycloheptylene, 1,5-(2-sec-butyl)cycloheptylene, 1,6-(2-sec-butyl)cycloheptylene, 1,7-(2-sec-butyl)cycloheptylene, 1,3-(2-tert-butyl)cycloheptylene, 1,4-(2-tert-butyl)cycloheptylene, 1,5-(2-tert-butyl)cycloheptylene, 1,6-(2-tert-butyl)cycloheptylene, 1,7-(2-tert-butyl)cycloheptylene, 1,2-cyclooctylene, 1,3-cyclooctylene, 1,4-cyclooctylene and 1,5-cyclooctylene, 1,3-(2-methyl)cyclooctylene, 1,4-(2-methyl)cyclooctylene, 1,5-(2-methyl)cyclooctylene, 1,6-(2-methyl)cyclooctylene, 1,7-(2-methyl)cyclooctylene, 1,8-(2-methyl)cyclooctylene, 1,3-(2-ethyl)cyclooctylene, 1,4-(2-ethyl)cyclooctylene, 1,5-(2-ethyl)cyclooctylene, 1,6-(2-ethyl)cyclooctylene, 1,7-(2-ethyl)cyclooctylene, 1,8-(2-ethyl)cyclooctylene, 1,3-(2-propyl)cyclooctylene, 1,4-(2-propyl)cyclooctylene, 1,5-(2-propyl)cyclooctylene, 1,6-(2-propyl)cyclooctylene, 1,7-(2-propyl)cyclooctylene, 1,8-(2-propyl)cyclooctylene, 2,3-(1,4-dioxanylene), 2,5-(1,4-dioxanylene) and 2,6-(1,4-dioxanylene), 2,4-morpholinylene, 3,4-morpholinylene, 2,5-tetrahydrofurylene, 3,4-tetrahydrofurylene, 1,2-pyrrolidinylene, 1,3-pyrrolidinylene, 2,5-pyrrolidinylene and 3,4-pyrrolidinylene and 1,2-piperidylene, 1,3-piperidylene, 1,4-piperidylene, 2,3-piperidylene or 2,6-piperidylene.

Further, in the definition of R₁ and R₂, a substituted or unsubstituted arylene having 5 to 30 carbon atoms may be 1,2-phenylene, 1,3-phenylene, 1,4-phenylene, 1,2-naphthylene, 2,3-naphthylene, 1,4-naphthylene, 1,5-naphthylene, 2,6-naphthylene, 1,8-naphthylene, 2,5-pyrylene and 3,4-pyrylene, 2,3-pyridylene, 2,4-pyridylene, 2,5-pyridylene, 2,6-pyridylene, 3,5-pyridylene, 2,4-pyrimidylene, 2,5-pyrimidylene, 2,3-pyrazylene, 2,5-pyrazylene and 2,6-pyrazylene, 3,5-pyrazolylene, 1,2-imidazolylene, 1,4-imidazolylene, 1,5-imidazolylene, 2,4-imidazolylene, 2,5-imidazolylene, 2,4-thiazolylene and 2,5-thiazolylene, 3,5-(1,2,4-triazylene), 3,6-(1,2,4-triazylene), 2,4-(1,3,5-triazylene), 3,5-quinaldylene, 3,6-quinaldylene, 3,8-quinaldylene, 5,8-quinaldylene, 3,5-quinolinylene, 3,6-quinolinylene, 3,8-quinolinylene, 5,8-quinolinylene, 2,4-benzimidazolylene, 2,5-benzimidazolylene and 1,3-isoquinolylene, 1,4-isoquinolylene, 1,5-isoquinolylene, 1,6-isoquinolylene, 2-methyl-1,3-phenylene, 2-methyl-1,4-phenylene, 2-methyl-1,5-phenylene, 2-methyl-1,6-phenylene, 2,3-dimethyl-1,4-phenylene, 2,3-dimethyl-1,5-phenylene, 2,3-dimethyl-1,6-phenylene, 2,4-dimethyl-1,3-phenylene, 2,4-dimethyl-1,5-phenyl, 2,4-dimethyl-1,6-phenylene, 2,5-dimethyl-1,3-phenylene, 2,5-dimethyl-1,4-phenylene, 2,5-dimethyl-1,6-phenylene, 2,4,5-trimethyl-1,3-phenylene, 2,4,5-trimethyl-1,6-phenylene, 2,4,6-trimethyl-1,3-phenylene, 2-ethyl-1,3-phenylene, 2-ethyl-1,4-phenylene, 2-ethyl-1,5-phenylene 2-ethyl-1,6-phenylene, 2,3-diethyl-1,4-phenylene, 2,3-diethyl-1,5-phenylene, 2,3-diethyl-1,6-phenylene, 2,4-diethyl-1,3-phenylene, 2,4-diethyl-1,5-phenylene, 2,4-diethyl-1,6-phenylene, 2,5-diethyl-1,3-phenylene, 2,5-diethyl-1,4-phenylene, 2-methoxy-1,3-phenylene, 2-methoxy-1,4-phenylene, 2-methoxy-1,5-phenylene, 2-methoxy-1,6-phenylene, 2,3-dimethoxy-1,4-phenylene, 2,3-dimethoxy-1,5-phenylene, 2,3-dimethoxy-1,6-phenylene, 2,4-dimethoxy-1,3-phenylene, 2,4-dimethoxy-1,5-phenylene, 2,4-dimethoxy-1,6-phenylene, 2,5-dimethoxy-1,3-phenylene, 2,5-dimethoxy-1,4-phenylene, 2,5-dimethoxy-1,6-phenylene, 2,4,5-trimethoxy-1,3-phenylene, 2,4,5-trimethoxy-1,6-phenylene, 2,4,6-trimethoxy-1,3-phenylene, 2-ethoxy-1,3-phenylene, 2-ethoxy-1,4-phenylene, 2-ethoxy-1,5-phenylene, 2-ethoxy-1,6-phenylene, 2,3-diethoxy-1,4-phenylene, 2,3-diethoxy-1,5-phenylene, 2,3-diethoxy-1,6-phenylene, 2,4-diethoxy-1,3-phenylene, 2,4-diethoxy-1,5-phenylene, 2,4-diethoxy-1,6-phenylene, 2-chloro-1,3-phenylene, 2-chloro-1,4-phenylene, 2-chloro-1,5-phenylene, 2-chloro-1,6-phenylene, 2,3-dichloro-1,4-phenylene, 2,3-dichloro-1,5-phenylene, 2,3-dichloro-1,6-phenylene, 2,4-dichloro-1,3-phenylene, 2,4-dichloro-1,5-phenylene, 2-hydroxy-1,3-phenylene, 2-hydroxy-1,4-phenylene, 2-hydroxy-1,5-phenylene, 2-hydroxy-1,6-phenylene, 2,3-dihydroxy-1,4-phenylene, 2-cyano-1,3-phenylene, 2-cyano-1,4-phenylene, 2-cyano-1,5-phenylene, 2-cyano-1,6-phenylene, 2,3-dicyano-1,4-phenylene or 2,3-dicyano-1,5-phenylene.

For example, R₁ and R₂ may be each independently methylene, ethylene, propylene, isopropylene, cyclohexylene, cycloheptylene, phenylene, methylphenylene, ethylphenylene, methoxyphenylene or ethoxyphenylene.

The sulfur-containing polymer compound may include any one selected from the group consisting of the following repeat units.

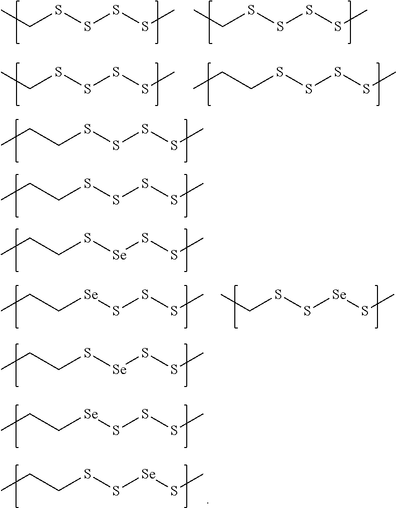

Since the sulfur-containing polymer compound contains the above-mentioned repeat unit, it do not have problems such as a decrease in refractive index even when stored at room temperature for a long time. In the case of a sulfur-containing polymer compound that does not include the above-mentioned repeat unit, there may be a problem that the refractive index is lowered when stored at room temperature for a long time, for example, 200 hours or more, 240 hours or more, or 300 hours or more.

The sulfur-containing polymer compound may include 1 to 1000, 2 to 800, 5 to 500, or 10 to 200 repeating units of Chemical Formula 1 or Chemical Formula 2.

Further, the weight average molecular weight of the sulfur-containing polymer compound may be 250 to 50,000, 500 to 40,000, or 1,000 to 30,000. When the weight average molecular weight of the sulfur-containing polymer compound is too large, there is a problem that the solubility in episulfide compounds is low, and it is difficult to obtain uniform physical properties such as uniform refractive index deviation and transparency deviation in the production of optical materials. When the weight average molecular weight is too small, the refractive index of the optical material formed after curing may be low.

As used herein, the weight average molecular weight (Mw) refers to a polystyrene-converted weight average molecular weight measured by gel permeation chromatography (GPC). In the process of measuring the polystyrene-converted weight average molecular weight measured by GPC, a detector and an analytical column, such as a commonly known analysis apparatus and differential refractive index detector can be used, and commonly applied temperature conditions, solvent, and flow rate can be used. Specific examples of the measurement conditions include a temperature of 30° C., a chloroform solvent, and a flow rate of 1 mL/min. Specific examples of the measurement condition are as follows: Waters PL-GPC220 instrument was used and a Polymer Laboratories PLgel MIX-B 300 mm length column was used. An evaluation temperature was 160° C., and 1,2,4-trichlorobenzene was used for a solvent at a flow rate of 1 mL/min. Samples were prepared at a concentration of 10 mg/10 mL and then supplied in an amount of 200 μL, and the values of Mw could be determined using a calibration curve formed using a polystyrene standard. 9 kinds of the polystyrene standards were used with the molecular weight of 2,000/10,000/30,000/70,000/200,000/700,000/2,000,000/4,000,000/10,000,000.

Meanwhile, the content of the sulfur-containing polymer compound may be 1 to 30 wt %, 2 to 25 wt %, or 5 to 20 wt % based on 100 wt % of the total curable composition. When the content of the sulfur-containing polymer compound is too large, there is a problem that the haze of the optical material formed after curing is increased, and the yellowness is also increased, and when the content of the sulfur-containing polymer compound is too small, there is a problem that the refractive index of the optical material formed after curing is lowered.

The sulfur-containing polymer compound may be prepared via the following Reaction Scheme 1 or Reaction Scheme 2, but is not limited thereto.

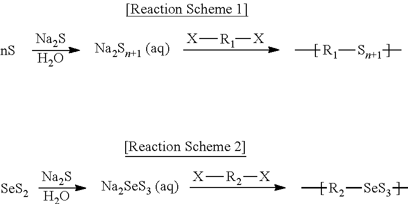

The sulfur-containing polymer compound can be prepared by dissolving sulfur (nS) or selenium disulfide (SeS₂) in an aqueous Na₂S solution and then polymerizing it with a difunctional organic halogen compound. At this time, in Reaction Schemes 1 and 2, the definitions of R₁, R₂ and n are as described above, the Na₂S aqueous solution may be a LI₂S aqueous solution or a K₂S aqueous solution, and the difunctional organic halogen compound may be a polyfunctional organic halogen compound with three or more functionalities, a bifunctional or polyfunctional organic tosylate compound, a bifunctional or polyfunctional organic mesylate compound, or the like.
[symbol] R₂—SeS₃ [symbol] formed in the Reaction Scheme 2 is one example, which may be [symbol] R₂—Sₐ—Se—S_{b} [symbol] (where a+b is 3), but is not limited thereto.

Conventionally, a thiol compound including a thiol group (—SH) was included in the curable composition for forming a high refractive index optical material, but in the case of a composition using a thiol compound, the curing reaction proceeds immediately after mixing and the viscosity increases sharply, and further, rapid curing causes a striae phenomenon, which causes a problem that that the optical material formed of such a composition is inferior in optical properties and physical properties.

However, since the curable composition for forming a high refractive index optical material according to the one embodiment includes the sulfur-containing polymer compound, a rapid curing reaction does not occur immediately after mixing, whereby long-term storage is possible, and a striae phenomenon due to rapid curing also may not occur.

The episulfide compound included in the curable composition may be represented by the following Chemical Formula 3.

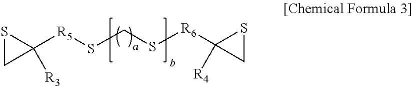

in Chemical Formula 3,
R₃ and R₄ are each independently hydrogen or an alkyl having 1 to 10 carbon atoms,
R₅ and R₆ are each independently a single bond or an alkylene having 1 to 10 carbon atoms,
a is an integer of 0 to 4, and
b is an integer of 0 to 6.

The episulfide compound, due to the above explained specific chemical structure, may comprise high content of sulfur(S) atoms having large atomic refraction in the molecule, and by such high sulfur atom content, may increase the refractive index of the cured product.

And, the episulfide compound may be cured by ring opening polymerization, and alkylene sulfide groups formed by the ring opening polymerization of episulfide groups may further increase the high refractive index of the cured product.

Meanwhile, in the Chemical Formula 3, R₃ and R₄ may be each independently hydrogen or a methyl group, but is not limited thereto.

And, R₅ and R₆ may be each independently a single bond, methylene, ethylene, propylene, isopropylene, butylene, or isobutylene, but is not limited thereto.

And, a and b may be each independently 0 or 1.

The a of the Chemical Formula 3 refers to the carbon number of an alkylene group included in a thioether repeat unit, and if a is too large, the length of a carbon chain in the molecule may lengthen, and thus, the glass transition temperature of the cured product may be lowered and heat resistance of the cured product may be deteriorated, and a relative sulfur content may decrease, and thus, the refractive index of the cured product may be lowered.

The b of the Chemical Formula 3 refers to the repeat number of a thioether repeat unit in which an alkylene group is linked by sulfur(S) atom, and if b is too large, the length of a carbon chain in the molecule may lengthen, and thus, the glass transition temperature of the cured product may be lowered and heat resistance of the cured product may be deteriorated.

And, the compound represented by the Chemical Formula 3 may be used alone, or in combination of two or more kinds.

The episulfide compound may comprise, for example, at least one selected from the group consisting of bispepithiopropyl)sulfide, bispepithiopropyl)disulfide, bis(8-epithiopropylthio)methane, 1,2-bis(6-epithiopropylthio)ethane, 1,3-bis(6-epithiopropylthio)propane, and 1,4-bispepithiopropylthio)butane, but is not limited thereto.

The episulfide compound may be included in the content of 50 to 99 wt %, 60 to 95 wt %, or 65 to 85 wt %, based on 100 wt % of the total curable composition. If the content of the episulfide compound is too large, the refractive index may be lowered or the physical and optical properties of the finally prepared optical material may be deteriorated. If the content of the episulfide compound is too small, the yellowness of the finally prepared optical material may increase.

Further, the weight ratio of the sulfur-containing polymer compound and the episulfide compound may be 1:2 to 1:30, 1:3 to 1:25, 1:4 to 1:20, 1:4 to 1:15, or 1:4 to 1:13. If the content of the episulfide compound is too small compared to the sulfur-containing polymer compound, there may be a problem that the yellowness may increase, and all of the polymer compounds cannot be dissolved. If the content of the episulfide compound is too high compared to the sulfur-containing polymer compound, the refractive index of the formed optical material may be low, or physical or optical properties may be deteriorated.

The curable composition for forming a high refractive index optical material may include sulfur (S₈) particles, selenium disulfide (SeS₂) particles, or a mixture thereof. The curable composition comprises sulfur particles and/or selenium disulfide particles, so that refractive index can be further improved, and the haze and yellow index can be lowered.

The sulfur (S₈) particles may have a particle size of 1 to 200 μm, 2 to 180 μm, or 3 to 170 μm. If the particle size of the sulfur particles is too small, it may not be possible to maintain the shape of the particles, and if the particle size is too large, the transmittance of the high refractive index plastic substrate may be lowered and the haze may be increased.

Additionally, the selenium disulfide (SeS₂) particles may have a particle size of 1 to 200 μm, 5 to 180 μm, or 10 to 170 μm. If the particle size of the selenium disulfide particles is too small, it may not be able to maintain the shape of the particles, and if the particle size is too large, the transmittance of the high refractive index plastic substrate may be lowered and the haze may be increased.

The particle size can be determined by, for example, dynamic light scattering method, laser diffraction method, centrifugal sedimentation method, FFF (Field Flow Fractionation) method, pore electrical resistance method, scanning electron microscopy (SEM) analysis, transmission electron microscopy (TEM) analysis or the like.

When the curable composition further comprises sulfur particles and/or selenium disulfide particles, the content of the sulfur particles may be 0.1 to 30 wt %, 1 to 20 wt %, 2 to 15 wt %, or 3 to 10 wt % relative to 100 wt % of the curable composition. Further, the content of selenium disulfide particles may be 0.1 to 30 wt %, 0.5 to 20 wt %, or 0.8 to 15 wt % relative to 100 wt % of the curable composition.

The curable composition may include a catalyst. The catalyst is not particularly limited as long as it is a catalyst commonly used in a curable composition for forming a high refractive index optical material, but the catalyst may be, for example, a nucleophile catalyst including an amine or a phosphine.

For example, the catalyst may include imidazole derivatives such as imidazole, 2-methylimidazole, 2-ethylimidazole, 2-ethyl-4-methylimidazole, 2-phenylimidazole, 4-phenylimidazole, 1-cyanoethyl-2-phenylimidazole, 1-(2-cyanoethyl)-2-ethyl-4-methylimidazole, and the like; amine compounds such as dicyandiamide, benzyldimethylamine, 4-(dimethylamino)-N,N-dimethyl benzylamine, 4-methoxy-N,N-dimethyl benzylamine, 4-methyl-N,N-dimethyl benzylamine, N,N-dicyclohexylmethylamine, N-ethyl-N-isopropylpropan-2-amine, N,N-dimethylcyclohexanamine, and the like; hydrazine compounds such as adipic acid dihydrazide, sebacic acid dihydrazide, and the like; phosphorus compounds such as triphenylphosphine, and the like, and pyridine compounds such as 2-bromopyridine, and the like. And, as commercially available catalysts, for example, 2MZ-A, 2MZ-OK, 2PHZ, 2P4BHZ, 2P4MHZ (product names of imidazole-based compounds) manufactured by Shikoku Kasei Kogyo Co., Ltd., U-CAT3503N, UCAT3502T (product names of block isocyanate of dimethylamine) manufactured by San-Apro Ltd., DBU, DBN, U-CATSA102, U-CAT5002 (bicyclic amidine compounds and salts thereof), and the like, may be mentioned.

The content of the catalyst may be 0.001 to 10 wt %, 0.01 to 5 wt %, or 0.1 to 1 wt %, based on 100 wt % of the total curable composition. If the content of the catalyst is too large, there is a problem that a curing speed may increase and thus storage stability of the composition may be deteriorated, and if it is too small, there is a problem that a curing speed may decrease and thus a thermal curing process may be lengthened.

Besides, the curable composition may further comprise other additives used to give specific functions to display substrates in the technical field to which the invention pertains, such as a UV absorber, a bluing agent, pigment, and the like.

According to another embodiment of the invention, there is provided optical material comprising: the episulfide compound and the sulfur-containing polymer compound.

For the episulfide compound included in the optical material, the sulfur-containing polymer compound, and sulfur particles, selenium disulfide, catalysts, and other additives that may be further included in the optical material, the above explanations regarding a photocurable composition are applied.

Such optical material may be prepared by curing the above explained curable composition. Specifically, the above explained curable composition or a homogeneous composition comprising the curable composition and various additives is prepared, and the composition may be injected into forms combining a mold made of glass, metal or polymer resin, and the like, and a resinous gasket, and heated and cured. Wherein, in order to facilitate taking out of the resin finally prepared after molding, the mold may be previously treated with a release agent, or a release agent may be further added to the above explained composition before use.

The curing temperature may vary according to the kind and content of compounds used, and the like, but it may be generally progressed at about 50 to about 120° C., or about 60 to about 100° C., and the curing time may be about 0.1 to about 72 hours, or about 0.5 to about 24 hours.

The curing reaction may be progressed by combining a process of maintaining a predetermined polymerization temperature as explained above for a certain time, a temperature increasing process, and a temperature decreasing process, and the like, and after the reaction is finished, post-treatment may be conducted at about 50 to about 150° C., or about 80 to about 120° C. for about 10 minutes to about 3 hours, so as to prevent deformation.

The optical material released after polymerization may be equipped with various functionalities, through the subsequent processes of dyeing, coating, and the like.

The optical material according to another embodiment may have a refractive index of 1.710 or more, 1.715 to 1.850, or 1.720 to 1.800 as measured at a wavelength of 500 nm or more and 750 nm or less, 550 nm or more and 700 nm or less, 600 nm or more and 650 nm or less, or 632.8 nm.

And, the optical material may have very high transmittance, specifically a transmittance value of 75% or more, 77% or more, 80 to 99%, or 85 to 99%, as measured according to JIS K 7361, when the thickness is 1 mm.

And, the optical material may have very low haze value, specifically a haze value of 35% or less, 33% or less, 31% or less, 25% or less, 20% or less, 10 to 1%, as measured according to JIS K 7136, when the thickness is 1 mm.

And, the optical material may have glass transition temperature of 65° C. or more, 67° C. or more, 68° C. or more, 70° C. to 99° C., or 72° C. to 99° C.

And, the optical material may have a yellow index (YI) of 0.1 to 50, 1 to 40, 1 to 35, 1 to 20, 1 to 15, or 1 to 10.

The optical material according to another embodiment may be included in a wearable device, and specifically, it may be used for lens of wearable devices, instead of glass or tempered glass.

Namely, the optical material has a high refractive index equivalent to glass, is lighter than glass or tempered glass, has excellent optical properties as well as mechanical properties such as hardness and strength, and the like, and has high glass transition temperature, and thus, it may be used as lenses of wearable devices, such as augmented reality devices or virtual reality devices that may be heated.

### Advantageous Effects

According the present disclosure, there are provided a curable composition for forming high refractive index optical material that is lighter than glass or tempered glass used in the existing lenses, and the like, has excellent strength and hardness, enables realization of various colors, enables realization of high refractive index, has low haze and yellow index value and thus has excellent optical properties, and has high glass transition temperature and thus is less deformed, and optical material comprising the same.

### DETAILED DESCRIPTION OF THE EMBODIMENTS

Hereinafter, the actions and effects of the invention will be described more specifically with reference to specific examples of the present disclosure. However, these examples are presented only as the illustrations of the invention, and the scope of the right of the invention is not determined thereby.

### Example 1

60 mg of the following 50 A (n is 10, weight average molecular weight: 2,500) as a sulfur-containing polymer compound, 948 mg of episulfide compound (the following 70 A), 48 mg of selenium sulfide particles (SeS₂, particle size: 50 μm), 144 mg of sulfur particles (S₈, particle size: 50 μm), 4 mg of the following catalyst (the following C1) were mixed, and the mixed solution was filtered using a glass filter having a pore size of 0.45 μm. And then, on each side of LCD Glass having a width of 10 cm and a height of 10 cm, slide glass having a thickness of 1 mm was placed, and about 1 g of the above mixed solution was applied onto the center of the LCD Glass, and then, covered with another LCD Glass, thus preparing a mold. It was put in an oven, and a curing reaction was progressed at about 60° C. for about 12 hours. After taking out from the oven, the LCD glasses were removed to obtain a plastic specimen, which is a flat optical material. The thickness of the plastic specimen was about 1 mm, when measured using a thickness gauge (Model: ID-C112XBS) manufactured by Mitutoyo corporation.

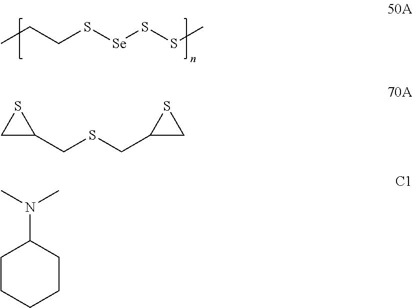

### Examples 2 to 7

A curable composition and an optical material which is a cured product thereof were prepared in the same manner as in Example 1, except that the sulfur-containing compound, episulfide compound, selenium sulfide particles, sulfur particles and the catalyst were used in the compounds and contents shown in Table 1 below.

### Comparative Example 1

1,000 mg of sulfur particles were added to a 5 ml vial, and stirred at 130° C. until completely dissolved. After all the sulfur was dissolved, 538 mg of divinylbenzene (DVB) was added, and the mixture was stirred at 130° C. for 150 minutes. Then, the mixed solution was dropped into a simple mold, cured at a temperature of 130° C. for 12 hours, and cooled at room temperature for 1 hour to prepare a plastic specimen with a thickness of about 1 mm.

### Comparative Examples 2 to 4

A curable composition and an optical member which is a cured product thereof were prepared in the same manner as in Example 1, except that the episulfide compound, selenium sulfide particles, sulfur particles and the catalyst were used in the compounds and contents shown in Table 1 below. Meanwhile, 70B used in Comparative Examples 2 to 4 are as follows.

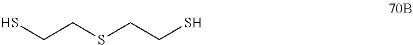

TABLE 1

| | Sulfur- | | | | | | | Chalcogen |
|---|---|---|---|---|---|---|---|---|
| | containing | | | Selenium | | | | element |
| | polymer | | Episulfide | disulfide | Sulfur | | | (S, Se) |
| | compound | Divinylbenzene | compound | particles | particles | Catalyst | 70B | content |
| | (50 A, mg) | (mg) | (70 A, mg) | (mg) | (mg) | (mg) | (mg) | (wt %) |
| Example 1 | 60 | — | 948 | 48 | 144 | 4.0 | — | 62.38 |
| Example 2 | 150 | — | 750 | 10 | 90 | 2.4 | — | 61.75 |
| Example 3 | 180 | — | 750 | 10 | 60 | 2.4 | — | 61.01 |
| Example 4 | 156 | — | 900 | 24 | 120 | 4.0 | — | 62.24 |
| Example 5 | 144 | — | 900 | 48 | 108 | 2.4 | — | 62.49 |
| Example 6 | 168 | — | 900 | 24 | 108 | 2.4 | — | 62.00 |
| Example 7 | 168 | — | 900 | 12 | 120 | 2.4 | — | 62.00 |
| Example 8 | 156 | — | 900 | — | 144 | 4.0 | — | 62.24 |
| Comparative | — | 538 | — | — | 1,000 | — | — | 65.00 |
| Example 1 | | | | | | | | |
| Comparative | — | — | 850 | — | — | 4 | 150 | 55.20 |
| Example 2 | | | | | | | | |
| Comparative | — | — | 900 | 24 | 120 | 4 | 156 | 60.56 |
| Example 3 | | | | | | | | |
| Comparative | — | — | 900 | — | 120 | 4 | 180 | 59.81 |
| Example 4 | | | | | | | | |

Physical Property Evaluation

1. Evaluation of Transmittance, Haze and Yellow Index

For each of the optical materials of Examples and Comparative Examples, the transmittance (JIS K 7361) and haze (JIS K 7136) were measured in the thickness direction of the cured product based on in 1 mm standard thickness using NDH-5000 manufactured by Nippon Denshoku Industries Co. LTD, and the results were shown in the following Table 2.

And, for each specimen, the yellow index was measured using a colorimeter, and the results were shown in Table 2 below.

2. Measurement of Glass Transition Temperature (Tg)

For each of the optical materials of Examples and Comparative Examples, the glass transition temperature was measured using differential scanning calorimeter (DSC) manufactured by TA Instrument Inc., and the results were shown in Table 2 below.

3. Measurement of Refractive Index

For each of the optical materials of Examples and Comparative Examples, a refractive index value was measured at the wavelength of 632.8 nm using SPA-4000 prism coupler manufactured by Sairon Technology, and the results were shown in Table 2 below.

TABLE 2

| | | Glass | | | |
|---|---|---|---|---|---|
| | | transition | Yellow | | |
| | Refractive | temperature | index | Haze | Transmittance |
| | index | (° C.) | (Y.I.) | (%) | (%) |
| Example 1 | 1.7307 | 80.7 | 14.5 | 8.9 | 86.9 |
| Example 2 | 1.7272 | 70.5 | 6.5 | 19.7 | 86.8 |
| Example 3 | 1.7261 | 68.8 | 7.3 | 30.7 | 81.8 |
| Example 4 | 1.7310 | 73.9 | 7.0 | 4.9 | 89.2 |
| Example 5 | 1.7309 | 73.2 | 11.0 | 7.3 | 89.4 |
| Example 6 | 1.7294 | 72.4 | 10.5 | 24.3 | 80.6 |
| Example 7 | 1.7297 | 71.9 | 7.6 | 18.5 | 79.2 |
| Example 8 | 1.7314 | 76.48 | 7.3 | 5.1 | 83.4 |
| Comparative | 1.8419 | 57.0 | 103.3 | 40.7 | 72.2 |
| Example 1 | | | | | |
| Comparative | 1.6964 | 29.9 | 3.8 | 2.5 | 84.0 |
| Example 2 | | | | | |
| Comparative | 1.7140 | 41.9 | 4.2 | 4.5 | 85.0 |
| Example 3 | | | | | |
| Comparative | 1.7072 | 29.6 | 6.7 | 4.3 | 85.9 |
| Example 4 | | | | | |

Referring to Table 2, it was confirmed that the specimens comprising the composition according to Examples of the present disclosure not only exhibit excellent optical properties, including high glass transition temperature (Tg) and a refractive index of 1.7261 or more, but also exhibit high transmittance of 79.2% or more, low haze of 30.7% or less, and low yellow index of 14.5 or less.

On the other hand, it was confirmed that Comparative Example 1, in which the sulfur-containing polymer compound of the present disclosure was not used, has a significantly lower transmittance and a significantly higher yellow index and haze as compared with Examples, and thus is inferior in optical properties.

Additionally, it was confirmed that Comparative Examples 2 to 4, in which the compound (70B) containing a thiol group was used instead of the sulfur-containing polymer of the present disclosure, have a lower refractive index and a significantly lower glass transition temperature as compared with Examples.

4. Evaluation of the Amount of Change in Refractive Index

For the optical materials of Examples 4 and 8 and Comparative Example 1, precise refractive indices were measured using a prism coupler.

Specifically, the refractive index over time was measured for the optical material at room temperature, and the results are shown in Table 3 below. Additionally, the difference value between the maximum refractive index and the minimum refractive index is represented by ARI, and the average refractive index value is represented by RIₐᵥₑ.

TABLE 3

| Example 4 | | Example 8 | | Comparative Example 1 | |
|---|---|---|---|---|---|
| | Refractive | | Refractive | | Refractive |
| Time | index | Time | index | Time | index |
| (hr) | (n) | (hr) | (n) | (hr) | (n) |
| 0 | 1.7307 | 0 | 1.7313 | 0 | 1.8446 |
| 12 | 1.7312 | 12 | 1.7316 | 12 | 1.8422 |
| 24 | 1.7305 | 24 | 1.7312 | 24 | 1.8409 |
| 36 | 1.7309 | 36 | 1.7312 | 36 | 1.8410 |
| 48 | 1.7313 | 48 | 1.7317 | 48 | 1.8410 |
| ΔRI | 0.0008 | ΔRI | 0.0005 | ΔRI | 0.0037 |
| RIₐᵥₑ | 1.7309 | RIₐᵥₑ | 1.7314 | RIₐᵥₑ | 1.8419 |

According to Table 3, it was confirmed that in Examples 4 and 8, there is almost no change in the refractive index over time even when having high average refractive index of 1.7309 or more. Meanwhile, it was confirmed that in Comparative Example 1, the refractive index significantly changed over time.

1. A curable composition for forming a high refractive index optical material, comprising an episulfide compound and a sulfur-containing polymer compound,
wherein the sulfur-containing polymer compound comprises at least one repeat unit selected from the group consisting of a repeat unit containing Sₙ₊₁ (n is an integer of 1 to 20) and a repeat unit containing selenium and sulfur.

2. The curable composition according to claim 1, wherein:
the sulfur-containing polymer compound comprises repeat units represented by the following Chemical Formula 1 or 2: [symbol]
R₁—Sₙ₊₁ [symbol] [Chemical Formula 1]
in the Chemical Formula 1,
R₁ is a substituted or unsubstituted alkylene having 1 to 20 carbon atoms; a substituted or unsubstituted cycloalkylene having 3 to 40 carbon atoms; a substituted or unsubstituted arylene having 5 to 30 carbon atoms; —a substituted or unsubstituted heteroarylene having 2 to 30 carbon atoms containing at least one of oxygen (O), nitrogen (N) and sulfur (S) atoms; —RₐOR_{b}—; —R_{c}COOR_{d}—; —RₑSO₂R_{f}— or —R_{g}SORₕ—, where Rₐ to Rₕ are each independently a single bond, a substituted or unsubstituted alkylene having 1 to 20 carbon atoms, a substituted or unsubstituted cycloalkylene having 3 to 40 carbon atoms, or a substituted or unsubstituted arylene having 5 to 30 carbon atoms, and
n is an integer of 1 to 20, [symbol]
R₂—Sₐ—Se—S_{b} [symbol] [Chemical Formula 2]
in the Chemical Formula 2,
R₂ is a substituted or unsubstituted alkylene having 1 to 20 carbon atoms; —a substituted or unsubstituted cycloalkylene having 3 to 40 carbon atoms; a substituted or unsubstituted arylene having 5 to 30 carbon atoms; a substituted or unsubstituted heteroarylene having 2 to 30 carbon atoms containing at least one of oxygen (O), nitrogen (N) and sulfur (S) atoms; —RₐOR_{b}—; —R_{c}COOR_{d}—; —RₑSO₂R_{f}— or —R_{g}SORₕ—, where Rₐ to Rₕ are each independently a single bond, a substituted or unsubstituted alkylene having 1 to 20 carbon atoms, a substituted or unsubstituted cycloalkylene having 3 to 40 carbon atoms, or a substituted or unsubstituted arylene having 5 to 30 carbon atoms,
a and b are each independently an integer of 0 or more and 10 or less, and
a+b is an integer of 1 or more and 20 or less.

3. The curable composition according to claim 2, wherein:
R₁ and R₂ are each independently methylene, ethylene, propylene, isopropylene, cyclohexylene, cycloheptylene, phenylene, methylphenylene, ethylphenylene, methoxyphenylene or ethoxyphenylene.

4. The curable composition according to claim 1, wherein:
the sulfur-containing polymer compound comprises any one selected from the group consisting of the following repeat units:

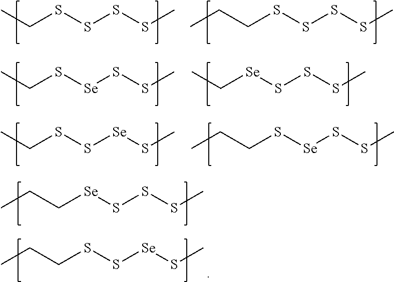

5. The curable composition according to claim 1, wherein:
a weight ratio of the sulfur-containing polymer compound and the episulfide compound is 1:2 to 1:30.

6. The curable composition according to claim 1,
comprising sulfur (S₈) particles, selenium disulfide (SeS₂) particles, or mixtures thereof.

7. The curable composition according to claim 6, wherein:
the sulfur (S₈) particles have a particle diameter of 1 to 200 μm, and the selenium disulfide (SeS₂) particles have a particle diameter of 1 to 200 μm.

8. The curable composition according to claim 1, wherein:
the episulfide compound is represented by the following Chemical Formula 3: 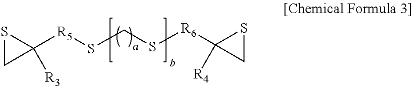
in the Chemical Formula 3,
R₃ and R₄ are each independently hydrogen or an alkyl having 1 to 10 carbon atoms,
R₅ and R₆ are each independently a single bond or an alkylene having 1 to 10 carbon atoms,
a is an integer of 0 to 4, and
b is an integer of 0 to 6.

9. The curable composition according to claim 8, wherein:
the episulfide compound comprises at least one selected from the group consisting of bis(β-epithiopropyl)sulfide, bis(β-epithiopropyl)disulfide, bis(β-epithiopropylthio)methane, 1,2-bis(β-epithiopropylthio)ethane, 1,3-bis(β-epithiopropylthio)propane, and 1,4-bis(β-epithiopropylthio)butane.

10. An optical material comprising an episulfide compound and a sulfur-containing polymer compound,
wherein the sulfur-containing polymer compound comprises at least one repeat unit selected from the group consisting of a repeat unit containing Sₙ₊₁ (n is an integer of 1 to 20) and a repeat unit containing selenium and sulfur.

11. The optical material according to claim 10, wherein:
the optical material has a glass transition temperature of at least 65° C.

12. The optical material according to claim 10, wherein:
the optical material has a refractive index of at least 1.710 as measured at a wavelength of 500 nm or more and 750 nm or less.

13. The optical material according to claim 10, wherein:
the optical material has a yellow index (YI) of 0.1 to 50.
